(19) United States
(12) Patent Application Publication
(10) Pub. No.: US 2011/0014385 A1
(43) Pub. Date: Jan. 20, 2011

(54) METHOD AND APPARATUS FOR COATING AN ARTICLE USING A SPRAY-COATING METHOD

(75) Inventors: Sampo Ahonen, Espoo (FI); Tommi Vainio, Soderkulla (FI); Markku Rajala, Vantaa (FI)

Correspondence Address: OLIFF & BERRIDGE, PLC, P.O. BOX 320850, ALEXANDRIA, VA, 22320-4850, US

(73) Assignee: BENEQ OY, Vantaa (FI)

(21) Appl. No.: 12/921,797

(22) PCT Filed: Apr. 2, 2009
(86) PCT No.: PCT/FI2009/000045

§ 371 Date: Sep. 24, 2010

(30) Foreign Application Priority Data
Apr. 3, 2008 (FI) 20080264

(51) Int. Cl. B05D 1/02; B05B 9/00; B05B 15/00

(52) U.S. Cl. 427/421.1; 118/58; 118/66

(57) ABSTRACT

The invention relates to a method and apparatus for coating an article using a spray-coating method. Coating can be produced by atomizing a fluid coating precursor material into droplets with an average diameter of 0.5 to 5 micrometres. The droplets are introduced onto the article to be coated at a velocity that exceeds the critical impaction velocity. The evaporation of the droplets can be controlled by controlling the concentration of the fluid precursor material solvent in the spray chamber.

### FIELD OF THE INVENTION

The present invention relates to the coating of an article using the spray-coating method. With the method and apparatus in accordance with the invention, coating can be advantageously produced by atomising a fluid coating precursor material into droplets with an average diameter ranging from 0.5 to 5 micrometres and by introducing the droplets onto the article to be coated at a velocity that exceeds the critical impaction velocity. The evaporation of the droplets can, in accordance with the invention, be controlled by controlling the concentration of the fluid precursor material solvent in the spray chamber.

### BACKGROUND OF THE INVENTION

As such, spray coating is a known method for applying coating. Typical examples of spray-coating are, for example, spray painting and pigment coating of paper.

Patent publication FI 111478 B, 19 Jul. 2000, Metso Paper, Inc., discloses a spray-coating method for paper coating in which method the coating mix is applied to the surface of a paper web by means of spray nozzles in which the coating mix is atomised into small droplets prior to spraying onto the paper web. The publication discloses a method in which the spray-coating is performed inside an enclosing hood, the interior walls of which can be made coolable, and the temperature and humidity of the hood can be can be set to desired values. The publication makes no mention of fluid droplet size and spray velocity.

Patent publication U.S. Pat. No. 4,656,963, 14 Apr. 1987, Takashi Yonehara et al., discloses a method for forming an extremely thin film on the surface of an object. In the method, aerosol is produced from the precursor material and introduced onto the surface of the substrate to be coated, and after evaporation of the solvent, a thin film is formed on the surface. The publication discloses the production of aerosol particles by ultrasonics, ranging in size from 1.5 to 10 micrometres. The publication provides no description of how the aerosol particles are introduced onto the surface of the substrate to be coated by means of impaction.

Patent publication U.S. Pat. No. 4,728,353, Glaverbel, 1 Mar. 1988, discloses an apparatus for forming a pyrolytic metal compound coating on a hot glass substrate. For the operation of the apparatus, it is essential that the gas atmosphere in the immediate vicinity of the face of the glass substrate is controlled by means of supplying preheated gas thereto that forms a protective atmosphere in the vicinity of the face of the glass substrate. The protective atmosphere makes it possible to prevent the entry of ambient air into the coating area. The publication discloses that the preheated gas is preheated air, meaning that the coating reactions take place in an oxygen-rich atmosphere. The feeding of coating precursor material by means of spraying is disclosed in the publication, but not the diameter of the mist droplet. Because in 1988 atomisers were not sufficiently advanced to produce small droplets, it has been obvious to a person skilled in the art at that time that the diameter of the mist droplet has been in the range of tens of micrometres. A publication by Arthur H. Lefebvre, Atomization and Sprays, Taylor&Francis, USA, 1989 discloses a set of different atomisers. The word ‘mist’ frequently used in patent publications refers to droplets of about 100 micrometres in diameter (page 80 of said publication), and the droplet size distributions for the pressure and air dispersion atomisers disclosed in said publication (in particular pp. 201-273) never show droplets of less than 10 micrometres, average diameters typically ranging from 30 to 80 micrometres. Evaporation of such droplets is possible within the period of 10 seconds mentioned in the publication, provided that the air temperature is several hundred degrees as described in the publication. However, the heating of air makes the solution expensive, in particular when large quantities of air are used as described in the publication.

Patent publication U.S. Pat. No. 5,540,959, Xingwu Wang, 30 Jun. 1996, discloses a method for preparing a coated substrate using mist particles. In the method, small droplets are produced that are heated with radio frequency energy to vaporise the droplets, after which the vapour is deposited onto a substrate. Said publication says nothing about the impingement, collision or impaction of fluid droplets onto the surface of the substrate.

Patent application publication US 2002/0100416 A1, James J. Sun., et al., 1 Aug. 2002, discloses a method for coating a substrate using aerosol wherein droplets larger than a certain droplet size are removed from the flow using an impaction plate. Said publication provides no description of the use of impaction for depositing droplets onto a substrate.

Patent publication U.S. Pat. No. 5,882,368, Vidrio Piaano De Mexico, S.A. DE C.V., 16 Mar. 1999, discloses a method for coating a hot glass substrate with small droplets. Said publication says nothing about the use of impaction for coating purposes.

The prior art does not disclose the advantages of having the fluid dispersed into small droplets and the droplets impacted onto the substrate to be coated.

### SUMMARY OF THE INVENTION

The purpose of the present invention is to provide a method in which coating is based on the impaction of small droplets, thereby making it possible to utilise the advantageous characteristics of small droplets.

This is achieved with the spray-coating method in accordance with the characterising part of claim 1 wherein fluid precursor material, of which small droplets are produced, is fed into an atomiser that atomises the fluid into small droplets. The average droplet diameter ranges from 0.5 to 5 μm, and the velocity of the droplets is such that the droplets are impacted onto the surface to be coated. With droplets with a diameter typically of the order of 0.5 micrometres, the velocity of the droplets must be at least 100 to 120 m/s. Impacting of droplets of less than 0.5 micrometres in diameter in a normal atmosphere, i.e. without using considerable negative pressure on the delivery side of the coated surface, can in practice only be achieved at low efficiency. The minimum velocity required for impaction decreases when the droplet size increases, and droplets of 5 micrometres in diameter are successfully impacted at the velocity of approximately 20 m/s. However, in terms of coating, it is preferable to have as small a droplet size as possible, because droplet diameter has an essential effect on droplet characteristics. The characteristics of 0.5 micrometre and 100 micrometre droplets are compared in Table I.

TABLE I

| | 0.5 μm | 100 μm |
|---|---|---|
| Characteristic | droplet | droplet (mist) |
| Average thermal velocity (cm/s) | 5 | 0.0004 |
| Gravitation velocity at 1 atm | 0.0001 | 25 |
| pressure (cm/s) | | |
| Evaporation time (s, water, 100% RH) | 0.01 | >1000 |
| Impaction velocity (m/s) | 100 | <1 |
| Specific surface area (water, cm2/g) | 40,000 | 50 |

In the method in accordance with the invention, the fluid precursor material employed consists of at least one solvent and at least one material dissolved in the solvent. The solvent can, for example, be water, alcohol or other organic solvent, and the material can, for example, be a salt of a metal, such as a nitrate, sulphate or chloride of a metal or equivalent. The fluid precursor material may also be a polymer precursor material consisting of at least one monomer.

In the method in accordance with the invention, droplets are sprayed in a spray chamber where the vapour pressure of the fluid precursor material solvent is controlled. In such a case it is possible to manipulate droplet evaporation by controlling the vapour pressure of the solvent inside the chamber. For example, the life of a droplet of 5 micrometres in original diameter with water as solvent is about 30 ms in dry air (relative humidity 0%), about 50% at 50% relative humidity, and more than 10 s at 100% relative humidity. Preferably, the method in accordance with the invention can be used for controlling the droplet diameter so that the average droplet diameter ranges from 0.5 to 1 μm before the droplet is impacted onto the surface to be coated. The solvent present in the droplet can also be essentially evaporated in its entirety before impaction, so that the material dissolved in the droplet, such as metal salt, forms a solid particle before the impaction.

A major technical benefit can be obtained by impacting the droplets onto the surface to be coated, because impaction makes it possible to have the majority of the droplets to impinge upon the surface to be coated, resulting in effective use of the precursor material. The Stokes number of the droplets must be sufficiently high for the impaction to occur, which in practical terms means that the impaction velocity of the droplet depends on the droplet size. The impaction mechanism has been described in, e.g., William C. Hinds, Aerosl Technology—Properties, Behavior; and Measurement of Airborne Particles, 2nd Edition, John Wiley & Sons, Inc., New York, 1999, in particular on pages 121-128.

### DESCRIPTION OF THE DRAWINGS

FIG. 1 illustrates an embodiment of the method in accordance with the invention, while at the same time explaining the principle of the apparatus in accordance with the invention.

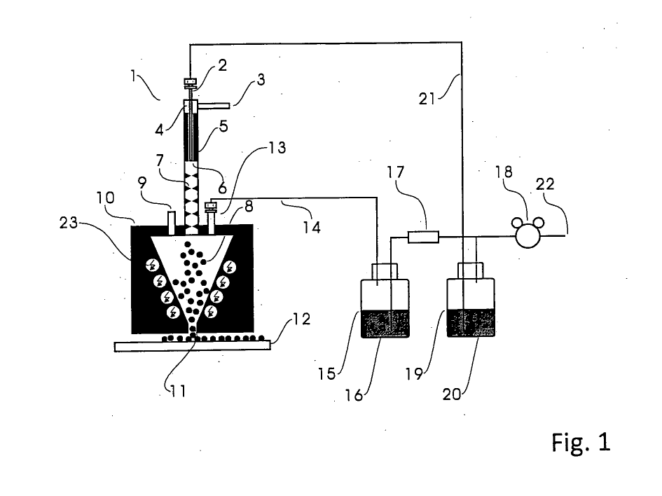

### DETAILED DESCRIPTION OF THE INVENTION

The schematic drawing 1 illustrates an embodiment of the method in accordance with the invention, namely a spray-coating apparatus 1, wherein fluid droplets 8 are sprayed onto the face of a substrate 12. Gas feed is introduced into the apparatus through a gas passage 22 via a pressure regulator 18. The gas employed may be an inert gas such as nitrogen N₂, argon Ar, carbon dioxide CO₂ or helium He, an oxidising gas such as oxygen O₂ or ozone O₃, or a reducing gas such as hydrogen H₂, carbon monoxide CO or methane CH₄. The gas employed may also be a reactive gas such as chlorine Cl₂ or silicon tetrafluoride SiF₄. The gas is used for pressurising the tank 19 for fluid precursor material 20, whereby the fluid precursor material 20 flows into the passage 21. The fluid precursor material 20 may be a solvent, emulsion, colloidal solution, alkoxide, or other organic fluid or equivalent. Preferably, the fluid precursor material 20 is a salt of a metal dissolved in a solvent, such as a nitrate, sulphate, hydroxide or chloride of a metal dissolved in methyl alcohol. The fluid precursor material 20 may also comprise at least a monomer or oligomer required for polymer formation, such as ethylene required for manufacturing polyethylene, or propylene required for manufacturing polypropylene. The fluid precursor material may also comprise a polymerisation initiator and/or a polymer modification agent, such as chlorine. From the passage 21, the fluid precursor material flows further to the fluid flow passage 2 of an atomiser 5. The gas required for the atomisation of the fluid 20 flows into the atomiser 5 through a flow passage 3 and a pressure equaliser 4. The atomising gas may be an inert gas such as nitrogen N₂, argon Ar, carbon dioxide CO₂ or helium He, an oxidising gas such as oxygen O₂ or ozone O₃, or a reducing gas such as hydrogen H₂, carbon monoxide CO or methane CH₄. The atomising gas may also be a reactive gas such as chlorine Cl₂ or silicon tetrafluoride SiF₄. As a result of the velocity difference between the gas flow and the fluid flow, the fluid atomises into small droplets at the atomiser end 6. The average droplet diameter is further reduced in the passage containing reducer sections 7, meaning that the average diameter of fluid droplets 8 arriving at a spray chamber 10 ranges from 0.5 to 5 micrometres. A gas flow may also be introduced into the spray chamber 10 from passage 9 and used, for example, for diluting the droplet concentration in the spray chamber 10 or for accelerating the flow discharged from the spray chamber 10 through a discharge opening 11. The design of the spray chamber 10 may also be used to the effect that the flow rate of the flow discharged from the discharge opening 11 exceeds the critical impaction velocity, which in this connection refers to the minimum velocity which the fluid droplet 8 must have in order to be successfully impacted onto a substrate 12. The evaporation velocity of fluid droplets 8 can be increased by introducing gas with a low concentration of fluid precursor material 20 solvent from the gas passage 9. The same effect is also accomplished by heating the spray chamber with accessories 23 or by introducing heated gas though the gas passage 9. The evaporation velocity of fluid droplets 8 can be decreased by introducing gas with a high concentration of fluid precursor material 20 solvent into the spray chamber 10. This can preferably be accomplished by introducing a gas flow from the gas passage 22 via a flow regulator 17 into a bubbler 15, wherein the gas flow passes though fluid 16, said fluid 16 preferably being fluid precursor material 20 solvent, whereby the gas flow introduced into the passage 14 contains vapour from the fluid 16, said vapour being further introduced into the spray chamber 10 through a gas nozzle 13.

The spray chamber 10 may vary in shape so that the discharge opening 11 may be round or preferably rectangular, and fluid droplets, gases or vapours can be introduced into the spray chamber 10 through several separate nozzles connected to the spray chamber 10, allowing the spray chamber 10, for example, to form a line-like coating unit for a moving web-like substrate, such as paper, plastic, textile, metal or glass web.

It is obvious to a person skilled in the art that the invention can have several embodiments. Consequently, the invention and its embodiments are not to be limited in scope to the embodiment described herein but can be varied within the scope of protection defined by the attached claims.

1. A spray-coating method wherein fluid precursor material, from which small droplets are produced, is fed into an atomiser that atomises the fluid into small droplets, wherein the average droplet diameter ranges from 0.5 to 5 μm and the velocity of the droplets is such that the droplets are impacted onto the surface to be coated.

2. Method in accordance with claim 1, wherein the velocity of the droplets is 20 to 120 m/s.

3. Method in accordance with claim 1, wherein the fluid precursor material consists of at least one solvent and at least one material dissolved in solvent.

4. Method in accordance with claim 3, wherein the solvent is alcohol and the dissolved material is metal salt.

5. Method in accordance with claim 3, wherein the fluid precursor material consists of at least one monomer.

6. Method in accordance with claim 1, wherein the droplets are sprayed in a spray chamber where the vapour pressure of the fluid precursor material solvent is controlled.

7. Method in accordance with claim 1, wherein the droplet evaporation is controlled in the spray chamber so that the average droplet diameter ranges from 0.5 to 1 μm before the droplet is impacted onto the surface to be coated.

8. Method in accordance with claim 1, wherein droplet evaporation is controlled in the spray chamber so that the solvent present in the droplet is essentially evaporated in its entirety before impaction.

9. A spray-coating apparatus comprising at least accessories for spraying fluid precursor material in a spray chamber, wherein the spray chamber has at least associated accessories for controlling the atmosphere of the spray chamber so that the spray chamber accommodates the desired vapour pressure of the solvent and an atomiser associated with the spray chamber for spraying the fluid precursor material so that average droplet size of the sprayed fluid is 0.5 to 5 micrometres.

10. An apparatus in accordance with claim 9, wherein the spray chamber comprises accessories for controlling the spray chamber temperature within the range of 20 to 65O° C.

11. An apparatus in accordance with claim 9, wherein the spray chamber is so formed that the velocity of fluid droplets accelerates before the fluid droplets are impacted onto a substrate.

12. An apparatus in accordance with claim 9, wherein the apparatus comprises accessories for introducing the gas flow into the spray chamber.
